(19) United States
(12) Patent Application Publication
(10) Pub. No.: US 2026/0170071 A1
(43) Pub. Date: Jun. 18, 2026

(54) SYSTEMS AND METHODS FOR SYNTHETIC PRIVATE DATA GENERATION FOR RETRIEVAL AUGMENTED GENERATION

(71) Applicant: Salesforce, Inc., San Francisco, CA (US)

(72) Inventors: Liangwei Yang, Chicago, IL (US); Zuxin Liu, Palo Alto, CA (US); Zhiwei Liu, Austin, TX (US); Rithesh Murthy, San Francisco, CA (US); Tulika Awalgaonkar, Mountain View, CA (US); Shelby Heinecke, San Francisco, CA (US); Huan Wang, Palo Alto, CA (US); Caiming Xiong, Menlo Park, CA (US); Juntao Tan, Palo Alto, CA (US)

(21) Appl. No.: 19/222,818

(22) Filed: May 29, 2025

Related U.S. Application Data
(60) Provisional application No. 63/733,998, filed on Dec. 13, 2024.

(51) Int. Cl. G06F 16/9535; G06F 16/901; G06F 16/93

(52) U.S. Cl. CPC G06F 16/9535; G06F 16/9024; G06F 16/93

(57) ABSTRACT

Embodiments described herein provide methods for retrieval augmented generation that leverage synthetic social graphs and persona-based data to improve AI personalization. In one approach, a large language model generates a social graph comprising multiple personas and their relationships, and creates profiles for these personas with randomly assigned characteristics. Synthetic documents, such as conversations between personas, are generated to reflect these characteristics. A training dataset is assembled from these documents, labeled according to the relevant persona attributes. A retrieval model is then trained to identify and retrieve conversations or documents in response to user queries about specific persona characteristics. An AI agent utilizes the trained retrieval model to generate responses to new user queries, drawing on the information retrieved from the synthetic documents to provide personalized answers.

### CROSS REFERENCE(S)

The instant application is a nonprovisional of and claims priority under 35 U.S.C. 119 to U.S. provisional application no. 63/733,998, filed Dec. 13, 2024, which is hereby expressly incorporated by reference herein in its entirety.

### TECHNICAL FIELD

The embodiments relate generally to machine learning systems for retrieval augmented generation, and more specifically to systems and methods for synthetic private data generation for retrieval augmented generation.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, current AI models often struggle with accurately retrieving and interpreting personal information from user data, which is essential for providing personalized responses. The challenge is compounded by the noisy and fragmented nature of user data, making it difficult for AI models to extract relevant personal details effectively.

### BRIEF DESCRIPTION OF THE DRAWINGS

FIG. 1 shows an example operation of an LLM based AI agent, according to some embodiments.

FIG. 2 illustrates a simplified diagram of a retrieval augmented generation (RAG) framework, according to some embodiments.

FIG. 3 illustrates recall performance of a number of retrieval models.

FIG. 4 illustrates a simplified diagram of a data generation pipeline, according to some embodiments

FIG. 5 illustrates an exemplary social graph, according to some embodiments

FIG. 6A is a simplified diagram illustrating a computing device implementing the RAG framework described in FIGS. 1-5, according to some embodiments.

FIG. 6B is a simplified diagram illustrating a neural network structure, according to some embodiments.

FIG. 7 is a simplified block diagram of a networked system suitable for implementing the RAG framework described in FIGS. 1-6B and other embodiments described herein.

FIG. 8 is an example logic flow diagram illustrating a method of retrieval augmented generation based on the framework shown in FIGS. 1-7, according to some embodiments.

FIGS. 9-11 provide charts illustrating exemplary performance of different embodiments described herein.

FIG. 12 provides an example of a user profile, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

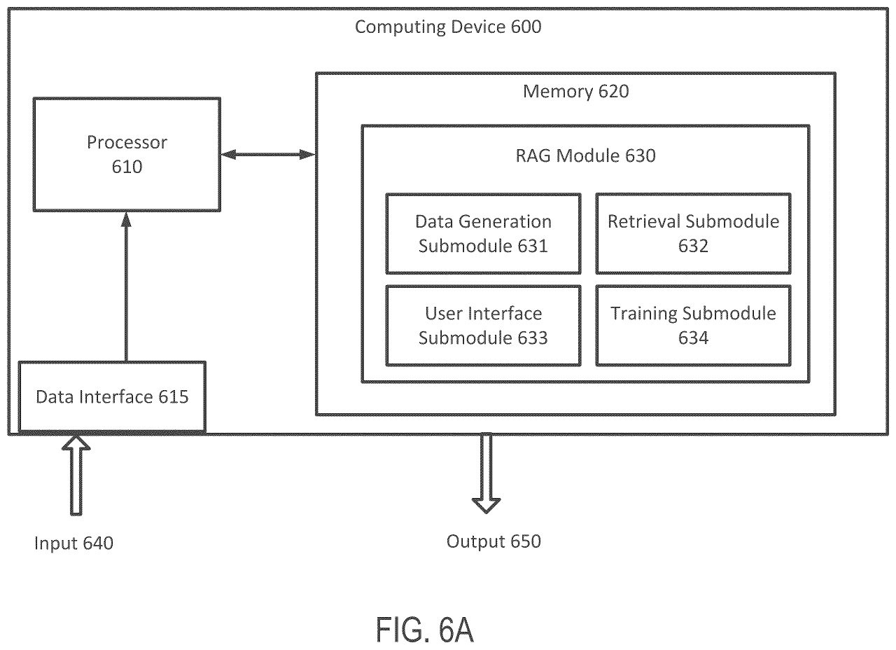

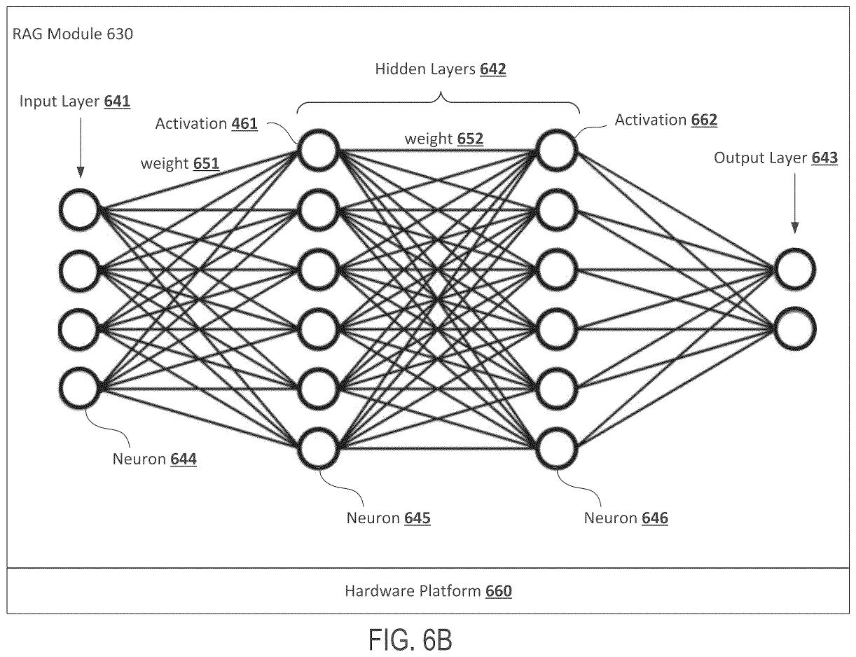

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Current AI models often struggle with accurately retrieving and interpreting personal information from user data, which is essential for providing personalized responses. The challenge is compounded by the noisy and fragmented nature of user data, making it difficult for AI models to extract relevant personal details effectively. There is a need for improved methods to generate synthetic user data that can be used to train retrieval models, enhancing the AI agents'ability to handle personalized tasks accurately.

Embodiments described herein address the challenge of enabling AI agents to accurately extract and interpret personal information from user data, which is critical for delivering truly personalized responses. Existing approaches have difficulty accessing real user data due to privacy concerns and the inherent noise and fragmentation in user documents. To overcome the limitations of existing approaches, embodiments herein introduce a synthetic data generation and retrieval-augmented generation (RAG) framework designed for robust personalization.

In some embodiments, the approach begins by generating a social graph, where nodes represent individual personas and edges represent relationships such as colleagues, friends, or family members. The social graph is constructed using a large language model (LLM) guided by preconfigured prompts, and is further refined through heuristic checks to ensure consistency and realism, such as enforcing symmetric relationships. A diverse set of synthetic user profiles is then created for the personas represented in the social graph, each representing a unique persona with detailed demographic, psychographic, and social attributes.

Once the social graph and profiles are established, a variety of synthetic documents are generated to simulate realistic private user data. These documents include multi-turn conversations between personas, user-AI interactions, and activity logs such as purchase histories. Some documents are crafted to subtly reveal specific personal attributes, while others serve as noise, containing general or unrelated information. This blend of relevant and irrelevant data mirrors the complexity of real-world user data and increases the robustness of downstream retrieval and reasoning tasks. The synthetic dataset is further enhanced by integrating real-world events and allowing for the evolution of personal attributes over time, making the data more dynamic and challenging.

A training dataset is then constructed by labeling the synthetic documents with the personal attributes they reveal. This dataset is used to train a retrieval model that learns to identify and extract relevant conversations or document segments in response to user queries about specific personal characteristics. For example, if a user asks about their favorite composer, the retrieval model is trained to locate the appropriate conversation where this preference is mentioned, even if the information is embedded within a noisy or lengthy document.

The trained retrieval model is integrated into a retrieval augmented generation (RAG) pipeline, where, upon receiving a user query, it retrieves the most relevant synthetic documents or document segments. An AI agent then generates a response based on the retrieved information, effectively simulating the process of answering personal questions by referencing private user data. This framework supports multiple document types and can be extended to include additional data sources, such as news or weather, to further diversify the training and evaluation scenarios.

By leveraging synthetic data and a structured retrieval-augmented approach, these embodiments provide a scalable and privacy-preserving solution for training and evaluating AI agents on personalized tasks. The system enables more sophisticated and effective personalization in real-world AI applications. The accurate retrieval of documents even in the presence of high amounts of noise, allows the retrieval model to retrieve fewer documents, and therefore provide a smaller context input to an LLM. This reduced and accurate context conserves memory and processing resources.

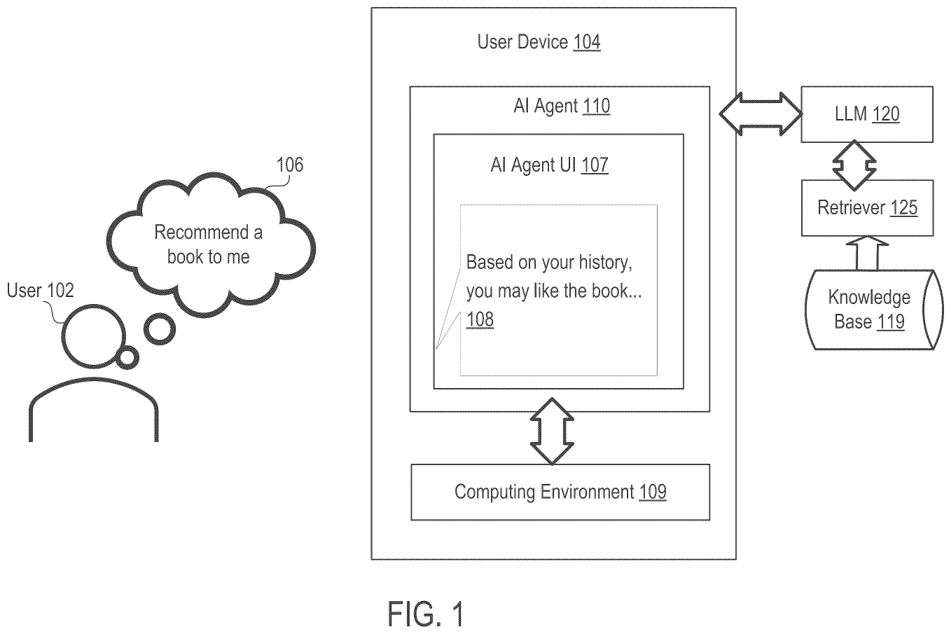

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “recommend a book to me” 106.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 6B.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to provide a recommendation, the LLM 120 may output a code script to execute on the computing environment 109 on the user device 104 to query an API (e.g., a public library API that provides book titles and summaries) and/or interface with APIs of other applications to perform the requested task, and/or the like.

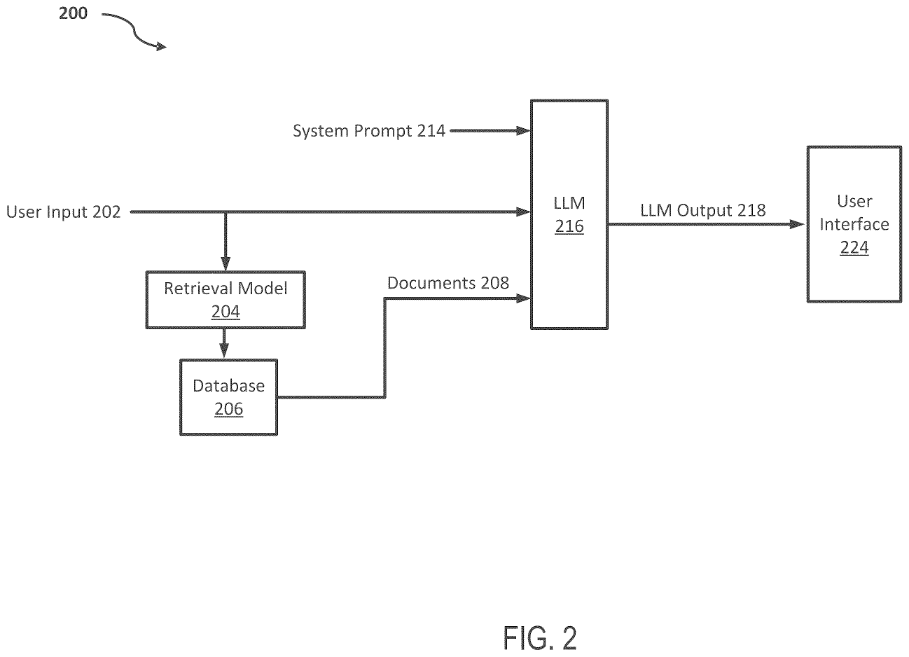

In this way, the LLM-based AI agent may facilitate end-to-end workflow to automate the task request 106. However, in order to perform the requested task (e.g., recommend a book), the AI agent may first need to retrieve personal information about the user, which may only be available in noisy data sources which RAG systems have traditionally been poor at extracting information from. AI agent 110 may be configured to utilize the methods described herein to improve the accuracy of the responses in an efficient manner, as further described in FIGS. 2-8 below.

FIG. 2 illustrates a simplified diagram of a retrieval augmented generation (RAG) framework 200, according to some embodiments. Framework 200 brings together several key components to enable the generation of contextually informed responses to user queries by integrating retrieval and generative processes. The process begins with user input 202, which represents a query or request submitted by the user. This user input 202 is provided to retrieval model 204, which is tasked with searching for relevant information.

Retrieval model 204 operates by accessing database 206, which contains a broad collection of documents. These documents in database 206 may include articles, records, text conversations, user behavior logs for a website, user-AI interactions, or other data sources that could potentially contain information relevant to the user's query. Upon receiving user input 202, retrieval model 204 searches through the documents in database 206 and selects a subset of the most relevant materials. In some embodiments, retrieval model 204 includes an embedding model for generating vector embeddings based on documents or prompts. Documents in database 206 are associated with vector embeddings generated by the embedding model, and are retrieved on the basis of the respective vector embedding's proximity to a vector embedding of the user input 202. In some embodiments, database 206 is or includes access to documents on the internet (e.g., websites). Internet document may be retrieved and catalogued prior to receiving user input 202, or may be searched for via retrieval model 204 in response to user input 202.

The retrieved documents 208, together with the original user input 202, are then combined with system prompt 214. System prompt 214 provides additional instructions or context to guide the behavior of large language model (LLM) 216. LLM 216 receives this combined input and processes it to generate a response, LLM output 218. LLM output 218 constitutes the system's answer or completion, informed by both the retrieved content and the generative capabilities of the LLM.

LLM output 218 is then presented to the user via user interface 224. User interface 224 acts as the communication bridge between the user and the system, displaying the generated response and enabling further interaction if desired. Through this coordinated flow, framework 200 demonstrates how user queries are transformed into informed, context-aware responses by leveraging both retrieval from a large database and advanced language generation.

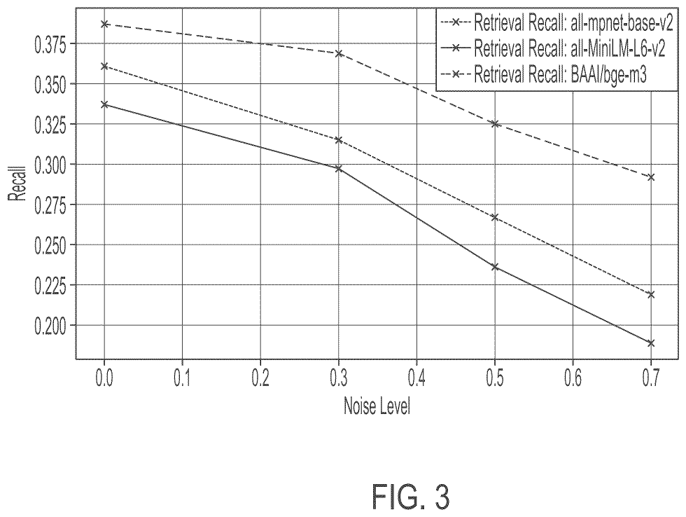

FIG. 3 illustrates recall performance of a number of retrieval models. The figure demonstrates that, across varying levels of noise in the data, existing retrieval models consistently struggle to extract the necessary information from user documents. Even as model size increases, the overall recall remains low, indicating that a significant portion of relevant personal information is not successfully retrieved. This highlights a core challenge in current retrieval-augmented generation systems: the inability of standard retrievers to reliably surface personal or contextually important details from large, noisy, and heterogeneous datasets, thereby limiting the effectiveness of downstream AI models in generating accurate, personalized responses.

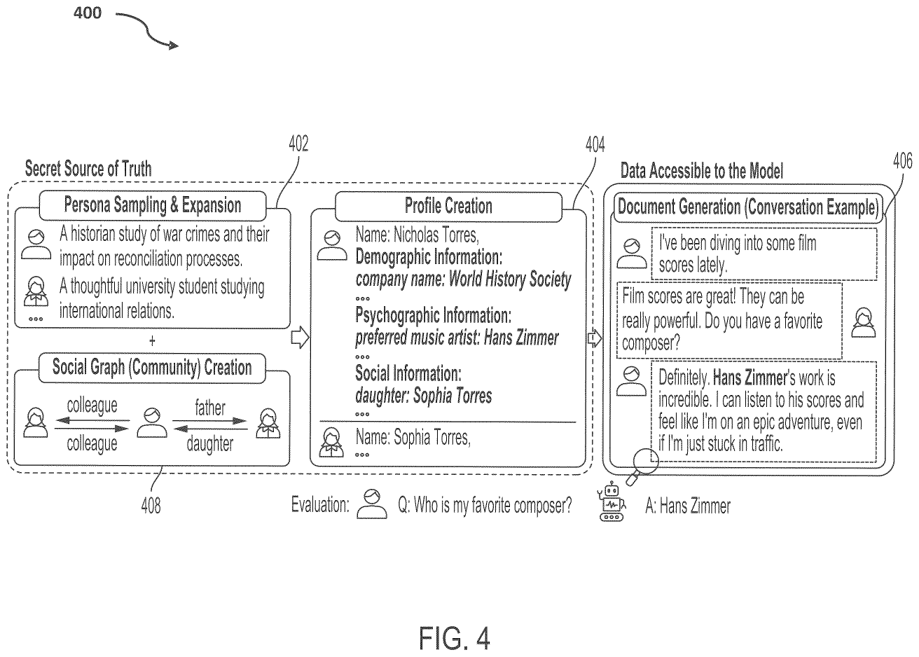

FIG. 4 illustrates a simplified diagram of a data generation pipeline, according to some embodiments. Framework 400 encompasses the entire process for generating synthetic personal data and associated documents, enabling the evaluation and training of AI models on tasks involving personal information retrieval and reasoning. The process begins with persona sampling 402 and social graph creation 408. Persona sampling 402 generates a diverse set of high level synthetic user personas (e.g., “a thoughtful university student studying international relations”). In some embodiments, persona sampling 402 leverages a combination of randomly sampled persona descriptions and names, which may be sourced from public datasets or generated by large language models (LLMs), to ensure a wide variety of backgrounds, preferences, and social roles. This step may be used to establish the diversity and realism of the synthetic user base.

Social graph creation 408 constructs a network of relationships among the sampled personas. Social graph creation 408 uses the initial set of personas to define connections (e.g., colleagues, family members, or friends) between individuals, forming a social graph where nodes represent personas and edges represent relationships. This step ensures that the generated social structure is both realistic and internally consistent, and may include heuristic checks to enforce rules such as symmetric relationships. For example, the symmetrical relationship for a “daughter” is a “father” or “mother.” The social graph serves as the foundation for grounding personal attributes and interactions in a realistic social context. In some embodiments, the social graph is generated by use of an LLM prompted to generate the connections based on the sampled personas.

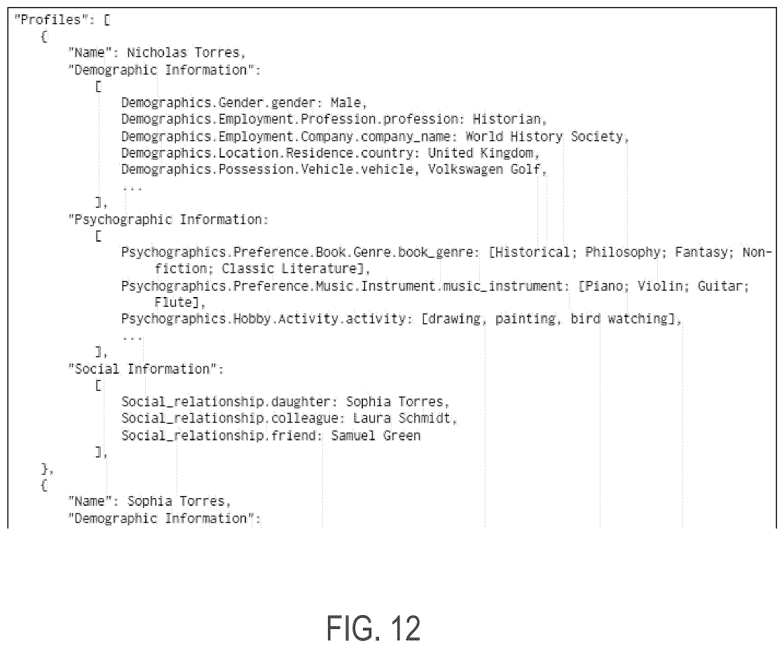

Profile creation 404 then completes the detailed profiles for each persona. In this stage, the system fills in demographic, psychographic, and social information for each individual, guided by both the persona's initial description and their position within the social graph. Profile creation 404 ensures that attributes such as occupation, preferences, and social ties are consistent with the relationships established in social graph creation 408. For example, colleagues in the social graph will share a workplace, and family members will have appropriately linked attributes. This step produces comprehensive, information-rich profiles that serve as the authoritative source for subsequent document generation. In some embodiments, profile creation 404 is performed via an LLM prompted to generate the personal information based on the persona's initial description and their position within the social graph. Profiles may be organized in a predefined structure such as a JSON format which associates specific information with categories. For example, a persona may have a “name” category with a value of “Nicholas Torres” and a “preferred music artist” category with a value of “Hans Zimmer.” An example user profile is provided in FIG. 12.

Document generation 406 synthesizes a variety of private user documents based on the completed profiles. These documents may include conversation histories between socially connected personas, user-AI interactions, purchase histories, and the like, each designed to reflect realistic daily activities and naturally reveal personal attributes. Document generation 406 employs prompt templates and strategies to ensure that some sessions subtly disclose personal information, while others introduce noise or reference real-world events, thereby simulating the complexity and heterogeneity of real user data. The generated documents are labeled with the relevant personal attributes they reveal (either at a document level or more specifically the location within the document which reveals the attribute), supporting the creation of training datasets. This enables the training and evaluation of retrieval models and AI agents on tasks such as retrieving conversations indicative of specific characteristics or answering queries about personal information.

In some embodiments, document generation is performed by use of an LLM prompted to generate the documents based on all the available generated information about the personas. For example, chats may be generated between two personas, and an LLM prompted to generate the chat may be further prompted to reveal an attribute of one of the personas within the chat. The revealing of the personal information may be done in a natural way which is not explicitly stating the information, for example the information that a persona's preferred music artist is Hans Zimmer may be revealed via a discussion about favorite songs and the persona in the generated chat may say their favorite song is one by Hans Zimmer. Other documents may be generated which do no reveal any of the information related to the personas, but may include general information such as a conversation regarding the news.

Together, the components of framework 400 (persona sampling 402, social graph creation 408, profile creation 404, and document generation 406) work in concert to produce a rich, realistic, and diverse synthetic dataset. This dataset supports the development of retrieval-augmented generation systems, as well as the training of AI agents to accurately extract and reason over personal information, directly addressing the challenges outlined in the claims and enabling robust evaluation of personalized AI capabilities. As indicated in FIG. 4, the documents generated at document generation 406 may be the only information available to a retrieval model, and any information regarding the personas would need to be derived from those documents.

A training dataset may include the documents generated at document generation 406, labeled with the information they reveal and/or the location within the documents which reveal the information. Training may be performed using such training data by having a user prompt that requests the personal information associated with a persona, and training the retrieval model to retrieve the relevant document labeled as revealing the requested information. Parameters of the model being trained may be updates so as to improve the chances that the correct document or passage is retrieved.

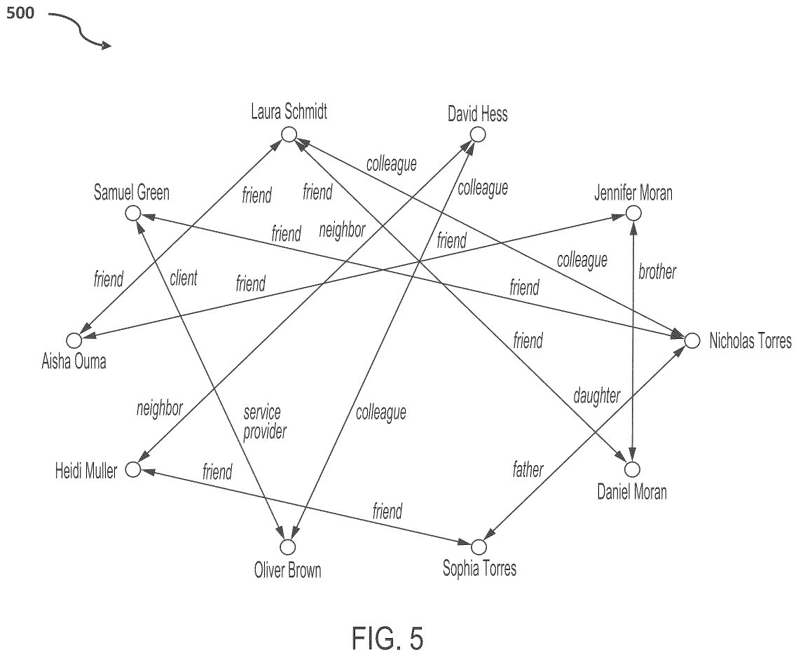

FIG. 5 illustrates an exemplary social graph 500, according to some embodiments. The social graph 500 represents a network of synthetic personas, each corresponding to a node, with edges denoting the relationships between them. In some embodiments, the social graph 500 is generated as part of a broader data generation pipeline, as described herein (e.g., as described in FIG. 4), where a plurality of personas is created and interconnected to form a realistic community structure. Each node in the social graph 500 corresponds to a unique persona, such as a historian, a university student, or a community organizer, and each edge encodes a specific relationship, such as colleague, father, daughter, or friend. The relationships are not arbitrary; rather, they are generated to reflect plausible social structures and are grounded in the attributes of the personas themselves.

To ensure the integrity and realism of the social graph 500, a heuristic check may be performed after the initial generation. This check enforces predetermined rules, such as the requirement that relationships be symmetric and semantically consistent. For example, if one node is connected to another as a “father,” the reciprocal relationship must be “son” or “daughter,” rather than an unrelated or inconsistent label such as “grandfather” or “colleague.” Similarly, if two nodes are linked as “colleagues,” both must share a workplace attribute in their respective profiles. This post-processing step may be used to maintain the logical consistency of the social graph 500 and for supporting downstream tasks that rely on accurate social context. In some embodiments, rather than a heuristic check, an LLM may be prompted to check for errors in the social graph 500. If an error is present in the social graph 500 (as discovered via an LLM or heuristic check), the social graph 500 may be updated so that it is logically consistent. The social graph 500 may be iteratively updated until it is free of errors.

The social graph 500 generated in this manner serves as the foundation for subsequent stages of the data generation pipeline, including profile completion and document synthesis. By ensuring that each relationship is both symmetric and contextually appropriate, the system supports the creation of training datasets in which the connections between personas are meaningful and can be reliably used to generate or retrieve documents indicative of specific personal characteristics, as described in the claims. This approach enables the training and evaluation of retrieval models and AI agents on tasks that require understanding and reasoning over complex social structures, thereby advancing the development of personalized AI systems.

### Computer and Network Environment

FIG. 6A is a simplified diagram illustrating a computing device implementing the RAG framework described in FIGS. 1-5, according to one embodiment described herein. As shown in FIG. 6A, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for RAG module 630 that may be used to implement and/or emulate the systems and models, and/or to implement any of the methods described further herein. RAG module 630 may receive input 640 such as an input training data (e.g., labeled generated documents) via the data interface 615 and generate an output 650 which may be a response and/or a retrieved document.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a user prompt, from a user via the user interface.

In some embodiments, the RAG module 630 is configured to generate synthetic private documents and train a retrieval model for use in a RAG framework as described herein. The RAG module 630 may further include data generation submodule 631 configured to generate synthetic data as described in FIGS. 4-5. The RAG module 630 may further include retrieval submodule 632 configured to retrieve documents as described herein. The RAG module 630 may further include user interface submodule 633 configured to provide a user interface for inputting prompts and receiving responses as described herein. The RAG module 630 may further include training submodule 634 configured to train a RAG framework (e.g., specifically training a retrieval model) using the synthetic training data as described herein.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the RAG module 630 described in FIG. 6A, according to some embodiments. In some embodiments, the RAG module 630 and/or one or more of its submodules 631-634 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as a user prompt. The number of nodes (neurons) in the input layer 641 may be determined by the dimensionality of the input data (e.g., the length of a vector of the user prompt). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the RAG module 630 receives an input 640 of a user prompt and transforms the input into an output 650 of a response to the prompt. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the RAG module 630 and/or one or more of its submodules 631-634 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a transformer-based LLM, and/or the like.

In one embodiment, the RAG module 630 and its submodules 631-634 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the RAG module 630 and its submodules 631-634 may be implemented by hardware, software and/or a combination thereof. For example, the RAG module 630 and its submodules 631-634 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the RAG module 630 and its submodules 631-634 and/or any other neural network models onto hardware platform 660, the neural network based modules 630 and its submodules 631-634 may be optimized for deployment by converting it to a suitable format, such as ONNX or TensorRT, to improve performance and compatibility. Next, depending on the size and workload requirements for modules 630 and its submodules 631-634, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the RAG module 630 and its submodules 631-634 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the RAG module 630 and its submodules 631-634 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the RAG module 630 and its submodules 631-634 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the RAG module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based RAG module 630 and one or more of its submodules 631-634 may be trained by iteratively updating the underlying parameters (e.g., weights 651, 652, etc., bias parameters and/or coefficients in the activation functions 661, 662 associated with neurons) of the neural network based on a loss function. For example, during forward propagation, the training data such as the synthetic training data described herein are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding location within a synthetic document revealing the requested information) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based RAG module 630 and one or more of its submodules 631-634 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

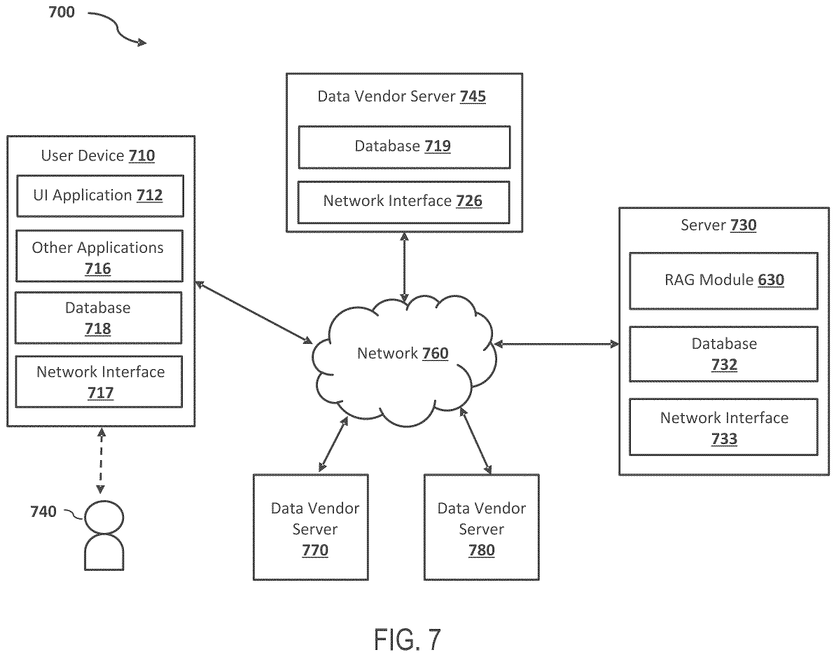

In some embodiments, RAG module 630 and its submodules 631-634 may be housed at a centralized server (e.g., computing device 600) or one or more distributed servers. For example, one or more of RAG module 630 and its submodules 631-634 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen user prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents.

FIG. 7 is a simplified block diagram of a networked system 700 suitable for implementing the RAG framework described in FIGS. 1-6B and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a response from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the RAG module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which RAG module 630 may generate a response via the process described in FIGS. 1-6B. The RAG module 630 may thus cause a display of a response at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view responses.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including synthetic training data to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the RAG module 630 and its submodules described in FIG. 6A. In some implementations, RAG module 630 may receive data from database 719 at the data vendor server 745 via the network 760 to generate responses. The generated responses may also be sent to the user device 710 for review by the user 740 via the network 760.

In one embodiment, an AI agent implementing the RAG module 630 and its submodules described in FIG. 6A may be built based on an LLM as described in FIG. 6B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the RAG module 630 and its submodules described in FIG. 6A may be implemented as a cloud-based AI agent which may be accessed by user device 710 via a chatbot application, a web application, customer support or SaaS applications. In another implementation, a client-side AI agent component may be delivered from the server 730 to user device 710 for local installation such that the client-side AI agent may be installed and runs directly on the user's device. Such local AI agent on the user device 710 may be available offline to adapt to privacy-sensitive applications. In another implementation, the AI agent implementing the RAG module 630 and its submodules described in FIG. 6A may adopt a hybrid cloud and client-based structure to balance computing speed, cost and privacy. For example, a local AI agent may handle basic AI queries locally, but complex queries may be sent to server 730 to process.

The database 732 may be stored in a transitory and/or non-transitory memory of the server 730. In one implementation, the database 732 may store data obtained from the data vendor server 745. In one implementation, the database 732 may store parameters of the RAG module 630. In one implementation, the database 732 may store previously generated responses, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

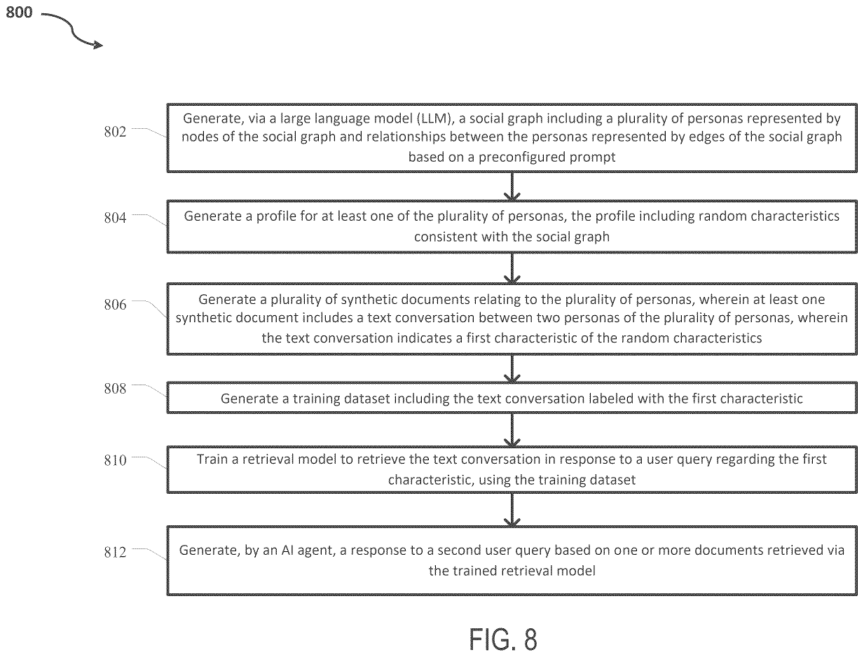

FIG. 8 is an example logic flow diagram illustrating a method of retrieval augmented generation based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the RAG module 630 (e.g., FIGS. 6A and 7) that generates synthetic private documents and/or trains a retrieval model for use in a RAG framework as described herein.

In some embodiments, method 800 is performed by a system such as computing device 600, user device 710, server 730, or another device or combination of devices. Inputs (e.g., user prompts or synthetic documents) may be received via a data interface such as data interface 615, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, the system generates, via a large language model (LLM), a social graph including a plurality of personas represented by nodes of the social graph and relationships between the personas represented by edges of the social graph based on a preconfigured prompt. In some embodiments, the system performs a heuristic check of the social graph to ensure consistency with one or more predetermined rules, such as requiring that relationships be symmetric, and updates the social graph in response to the heuristic check. For example, if a relationship is labeled as “father” in one direction, the reciprocal relationship must be “son” or “daughter,” ensuring semantic consistency and logical coherence within the social network. This post-processing step helps maintain the integrity of the generated social graph and supports downstream tasks that rely on accurate social context.

At step 804, the system generates a profile for at least one of the plurality of personas, the profile including random characteristics consistent with the social graph. In some embodiments, the random characteristics are generated via the LLM. The generated profiles may include demographic, psychographic, and social information, and are designed to be internally consistent and reflective of the relationships established in the social graph.

At step 806, the system generates a plurality of synthetic documents relating to the plurality of personas, wherein at least one synthetic document includes a text conversation between two personas of the plurality of personas, and the text conversation indicates a first characteristic of the random characteristics. In some embodiments, the plurality of synthetic documents includes documents of multiple types, including at least two of: conversations between personas, persona-AI interactions, and interaction logs for a website. These documents are crafted to simulate realistic interactions and activities, embedding personal attributes in a natural and contextually appropriate manner.

At step 808, the system generates a training dataset including the text conversation labeled with the first characteristic. In some embodiments, the training dataset further includes an indication of a location within the text conversation indicative of the first characteristic. This labeling enables the system to associate specific personal attributes with corresponding evidence in the synthetic documents, facilitating effective training and evaluation of retrieval models.

At step 810, the system trains a retrieval model to retrieve the text conversation in response to a user query regarding the first characteristic, using the training dataset. In some embodiments, the system generates a second plurality of synthetic documents relating to the plurality of personas, wherein the second plurality of synthetic documents does not indicate any characteristic of the random characteristics, and the training dataset further includes the second plurality of synthetic documents. In some embodiments, the second plurality of synthetic documents is generated based on retrieved information from an information source including at least one of: news, or weather. The inclusion of both relevant and irrelevant documents in the training dataset helps the retrieval model learn to distinguish between information that is indicative of personal characteristics and general or noisy content.

At step 812, the system generates, by an AI agent, a response to a second user query based on one or more documents retrieved via the trained retrieval model. The AI agent leverages the retrieved documents to answer queries about personal attributes, demonstrating the system's ability to extract and utilize personal information from synthetic private data.

In some embodiments, method 800 is applicable in a variety of applications. For example, the task request received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like.

Embodiments described herein enable the creation of highly personalized AI assistants that can access, interpret, and reason over private user data. By generating realistic social graphs, user profiles, and diverse synthetic documents, the system can train retrieval-augmented models to answer queries about a user's preferences, social connections, and activities. This approach allows AI assistants to provide tailored recommendations, reminders, and responses that are grounded in the user's personal context. For example, a virtual assistant could suggest travel destinations based on a user's historical preferences and social network, or proactively remind the user of important events discussed in past conversations. The accurate retrieval of documents even in the presence of high amounts of noise, allows the retrieval model to retrieve fewer documents, and therefore conserve memory and processing resources.

In customer support environments, the invention can be used to simulate and train AI agents on complex, multi-turn interactions that reflect real-world customer scenarios. By generating synthetic conversations and interaction logs that encode various customer personas and issues, the system can train retrieval models to quickly identify relevant past interactions or solutions based on a new customer query. This enables automated support agents to provide more accurate, context-aware responses, reducing the need for human intervention and improving response times. The technical advantage lies in the system's ability to handle noisy, fragmented, or incomplete data, which is common in customer support logs, thereby enhancing the robustness and reliability of automated support platforms.

Embodiments herein have practical applications in the domain of security and privacy testing for AI systems. By generating synthetic private data that mimics real user information and interactions, organizations can rigorously test the privacy-preserving capabilities of AI models without exposing actual sensitive data. This allows for the evaluation of how well AI systems can extract, utilize, or inadvertently leak personal information, supporting the development of more secure and privacy-compliant AI solutions. The technical benefit is the ability to conduct comprehensive, large-scale testing in a controlled environment, improving the trustworthiness and safety of AI deployments in sensitive domains such as finance, healthcare, or government.

### Example Results

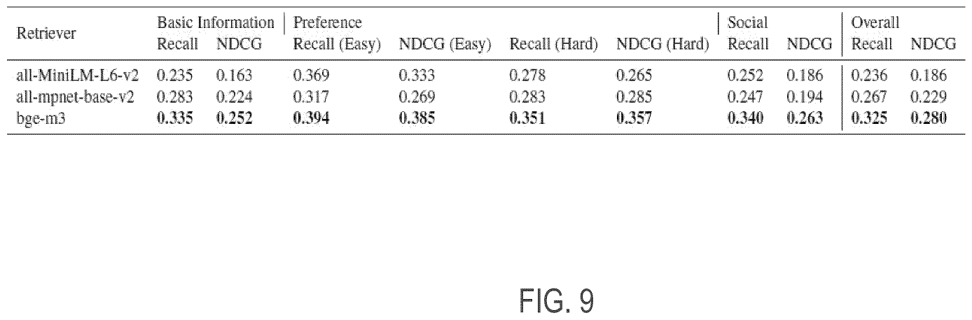

FIGS. 9-11 provide charts illustrating exemplary performance of embodiments described herein, comparing various models and metrics used in the experiments. The experiments evaluated the performance of different retrieval-augmented generation (RAG) models on personalized question-answering tasks using synthetic private user data. The models tested include GPT-40, GPT-40-mini, GPT-4, and GPT-3.5-turbo, each combined with three different retrievers: all-MiniLM-L6-v2, all-mpnet-base-v2, and bge-m3. The metrics used for evaluation were Recall, Normalized Discounted Cumulative Gain (NDCG), and F1-score. The experiments aimed to assess the models'ability to retrieve relevant information and generate accurate responses to personal questions.

FIG. 9 illustrates the retrieval evaluation results at a 50% noise level. The results indicate that larger retriever models generally achieve better performance. For example, the largest retriever model, bge-m3, outperforms all-mpnet-base-v2 and all-MiniLM-L6-v2 by 21.7% and 37.7% in Recall, and by 22.7% and 50.5% in NDCG, respectively. However, even the best retriever's overall Recall is only 0.325, indicating that more than half of the necessary information cannot be successfully extracted from irrelevant data. This underscores the challenge of the dataset for retrieval tasks.

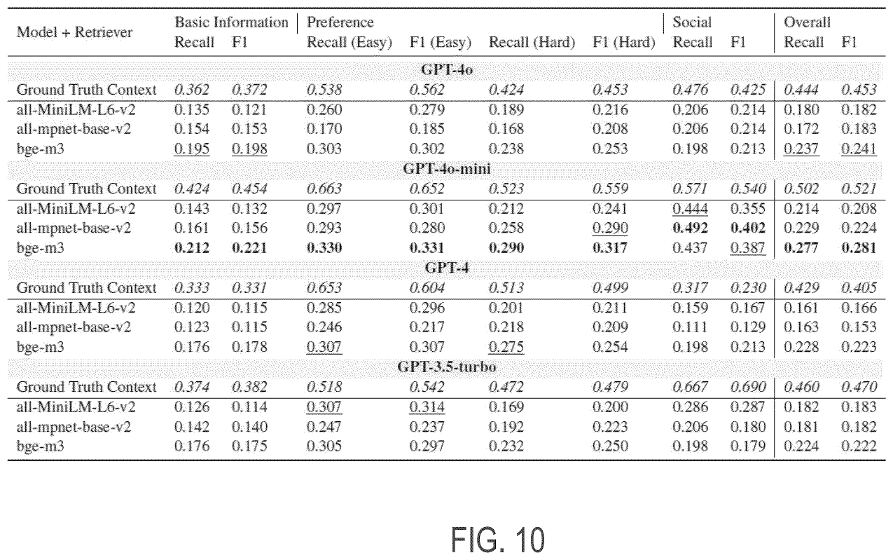

FIG. 10 shows the end-to-end evaluation results. For each base model, combining it with bge-m3 shows the best performance, which is consistent with the retrieval evaluation. Comparing the base models, while GPT-40 is considered state-of-the-art, GPT-40-mini achieves the best overall results. Additionally, GPT-3.5-turbo produces comparable outcomes to GPT-4, suggesting that a generally superior model does not necessarily excel at personal Q&A. The performance when providing ground-truth context significantly outperforms using retrieved context, with Recall scores around 50%, implying that some information is conveyed very implicitly, and the base models may not fully recognize it.

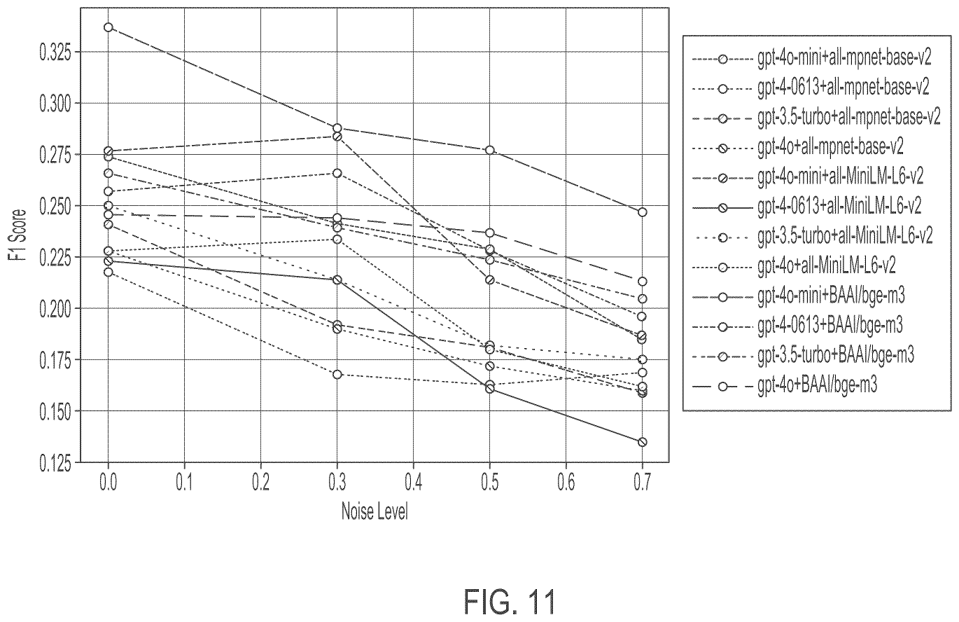

FIG. 11 illustrates end-to-end performance of models vs noise levels. As illustrated, the higher amount of noise in the documents reduces accuracy in retrieval performance which reduces overall accuracy. The model's ability to retrieve accurately in the presence of noise as described herein is able to overcome at least some of this trend.

FIG. 12 provides an example of a user profile, illustrating the type of synthetic personal data generated for evaluating AI models'ability to understand and utilize personal information. The user profile includes various attributes categorized into three meta-categories:
Demographic Information, Psychographic Information, and Social Information. For instance, the profile for Nicholas Torres includes demographic details such as his profession as a historian and his residence in the United Kingdom. Psychographic information reveals his preferences for historical and philosophical books, as well as his hobbies like drawing and bird watching. Social information indicates his relationships, such as his daughter Sophia Torres and his colleague Laura Schmidt.

This example profile is part of the synthetic data generation pipeline described herein, which aims to create realistic user profiles and private documents for training a retrieval model for RAG. The generated profiles serve as the ground truth for producing private documents, such as conversation histories and user-AI interactions, which are then used to train the AI models. The synthetic data ensures diversity and realism, allowing for a comprehensive assessment of the models'ability to extract and interpret personal information.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of retrieval augmented generation, the method comprising:
generating, via a large language model (LLM), a social graph including a plurality of personas represented by nodes of the social graph and relationships between the personas represented by edges of the social graph based on a preconfigured prompt;
generating a profile for at least one of the plurality of personas, the profile including random characteristics consistent with the social graph;
generating a plurality of synthetic documents relating to the plurality of personas, wherein at least one synthetic document includes a text conversation between two personas of the plurality of personas, wherein the text conversation indicates a first characteristic of the random characteristics;
generating a training dataset including the text conversation labeled with the first characteristic;
training a retrieval model to retrieve the text conversation in response to a user query regarding the first characteristic, using the training dataset; and
generating, by an AI agent, a response to a second user query based on one or more documents retrieved via the trained retrieval model

2. The method of claim 1, further comprising:
performing a heuristic check of the social graph to ensure consistency with one or more predetermined rules, wherein the one or more predetermined rules include at least a requirement that relationships be symmetric; and
updating the social graph in response to the heuristic check.

3. The method of claim 1, further comprising:
generating a second plurality of synthetic documents relating to the plurality of personas, wherein the second plurality of synthetic documents does not indicate any characteristic of the random characteristics,
wherein the training dataset further includes the second plurality of synthetic documents.

4. The method of claim 3, wherein the second plurality of synthetic documents is generated based on retrieved information from an information source including at least one of:
news, or weather.

5. The method of claim 1, wherein the plurality of synthetic documents includes documents of multiple types including at least two of:
conversations between personas;
persona-AI interactions; and
interaction logs for a website.

6. The method of claim 1, wherein the training dataset further includes an indication of a location within the text conversation indicative of the first characteristic.

7. The method of claim 1, wherein the random characteristics are generated via the LLM.

8. A system for retrieval augmented generation, the system comprising:
a memory that stores a large language model (LLM) model and a plurality of processor executable instructions;
a communication interface that receives an input user query; and
one or more hardware processors that read and execute the plurality of processor-executable instructions from the memory, wherein the plurality of processor-executable instructions are configurable to cause the system to perform operations comprising:
generating, via the LLM, a social graph including a plurality of personas represented by nodes of the social graph and relationships between the personas represented by edges of the social graph based on a preconfigured prompt;
generating a profile for at least one of the plurality of personas, the profile including random characteristics consistent with the social graph;
generating a plurality of synthetic documents relating to the plurality of personas, wherein at least one synthetic document includes a text conversation between two personas of the plurality of personas, wherein the text conversation indicates a first characteristic of the random characteristics;
generating a training dataset including the text conversation labeled with the first characteristic;
training a retrieval model to retrieve the text conversation in response to a user query regarding the first characteristic, using the training dataset; and
generating, by an AI agent, a response to a second user query based on one or more documents retrieved via the trained retrieval model

9. The system of claim 8, wherein the plurality of processor-executable instructions are further configurable to cause the system to perform operations comprising:
performing a heuristic check of the social graph to ensure consistency with one or more predetermined rules, wherein the one or more predetermined rules include at least a requirement that relationships be symmetric; and
updating the social graph in response to the heuristic check.

10. The system of claim 8, wherein the plurality of processor-executable instructions are further configurable to cause the system to perform operations comprising:
generating a second plurality of synthetic documents relating to the plurality of personas, wherein the second plurality of synthetic documents does not indicate any characteristic of the random characteristics,
wherein the training dataset further includes the second plurality of synthetic documents.

11. The system of claim 10, wherein the second plurality of synthetic documents is generated based on retrieved information from an information source including at least one of:
news, or weather.

12. The system of claim 8, wherein the plurality of synthetic documents includes documents of multiple types including at least two of:
conversations between personas;
persona-AI interactions; and
interaction logs for a website.

13. The system of claim 8, wherein the training dataset further includes an indication of a location within the text conversation indicative of the first characteristic.

14. The system of claim 8, wherein the random characteristics are generated via the LLM.

15. A non-transitory machine-readable medium comprising a plurality of instructions, executable by one or more processors, wherein the plurality of instructions are configurable to cause the one or more processors to perform operations comprising:
generating, via a large language model (LLM), a social graph including a plurality of personas represented by nodes of the social graph and relationships between the personas represented by edges of the social graph based on a preconfigured prompt;
generating a profile for at least one of the plurality of personas, the profile including random characteristics consistent with the social graph;
generating a plurality of synthetic documents relating to the plurality of personas, wherein at least one synthetic document includes a text conversation between two personas of the plurality of personas, wherein the text conversation indicates a first characteristic of the random characteristics;
generating a training dataset including the text conversation labeled with the first characteristic;
training a retrieval model to retrieve the text conversation in response to a user query regarding the first characteristic, using the training dataset; and
generating, by an AI agent, a response to a second user query based on one or more documents retrieved via the trained retrieval model

16. The non-transitory machine-readable medium of claim 15, wherein the plurality of instructions are further configurable to cause the one or more processors to perform operations comprising:
performing a heuristic check of the social graph to ensure consistency with one or more predetermined rules, wherein the one or more predetermined rules include at least a requirement that relationships be symmetric; and
updating the social graph in response to the heuristic check.

17. The non-transitory machine-readable medium of claim 15, wherein the plurality of instructions are further configurable to cause the one or more processors to perform operations comprising:
generating a second plurality of synthetic documents relating to the plurality of personas, wherein the second plurality of synthetic documents does not indicate any characteristic of the random characteristics,
wherein the training dataset further includes the second plurality of synthetic documents.

18. The non-transitory machine-readable medium of claim 17, wherein the second plurality of synthetic documents is generated based on retrieved information from an information source including at least one of: news, or weather.

19. The non-transitory machine-readable medium of claim 15, wherein the plurality of synthetic documents includes documents of multiple types including at least two of:
conversations between personas;
persona-AI interactions; and
interaction logs for a website.

20. The non-transitory machine-readable medium of claim 15, wherein the training dataset further includes an indication of a location within the text conversation indicative of the first characteristic.
